(19) United States
(12) Patent Application Publication
(10) Pub. No.: US 2008/0303738 A1
(43) Pub. Date: Dec. 11, 2008

(54) Cladding for a Microwave Antenna

(76) Inventor: Jochen Christ, Besigheim (DE)

Correspondence Address: COATS & BENNETT, PLLC, 1400 Crescent Green, Suite 300, Cary, NC, 27518, US

(21) Appl. No.: 11/572,478

(22) PCT Filed: Jul. 21, 2005
(86) PCT No.: PCT/EP05/53545

§ 371 Date: Dec. 12, 2007

(30) Foreign Application Priority Data
Jul. 22, 2004 (DE) 102004035614.9

(51) Int. Cl. H01Q 1/40

(52) U.S. Cl. 343/873

(57) ABSTRACT

A cladding (3; 3′; 3″) for a microwave antenna (1; 1h; 1v) comprises at least one cladding plate (4) having at least one portion which has a cross-section in the shape of a piece of logarithmic spiral in a first section plane, the section angle α between the radius and the normal of the spiral fulfilling the condition tan α=√εR, wherein εR is the dielectric constant of the material of the cladding plate (4).

The present invention relates to a cladding plate for cladding a microwave antenna, and to an assembly comprising such a cladding plate and a microwave antenna.

Such antennas, which may be highly directional antennas for point-to-point transmission or sector antennas for point-to-multipoint transmission, must often be covered by cladding plates on buildings in order to avoid a deterioration of the aspect of the building. Such cladding plates inevitably have an influence on the radiation pattern of the antenna. In order to keep this influence small, it is known e. g. from DE 199 02 511 A1 to adapt the thickness d of such a cladding plate to the vacuum wavelength λ₀ of the radiation emitted by the antenna and to the dielectric constant ε_{R} of the plate material according to the formula

$$d = \frac{m}{2} \frac{{λ}_{0}}{\sqrt{{ɛ}_{R}}} .$$

A beam which is oriented perpendicular to the plate surface and is reflected at the exit side of the plate reaches the incidence side delayed by m wavelengths, so that it interferes, due to a phase shift π at the boundary, in phase opposition with the incident beam and thus suppresses reflection at the cladding plate.

A wave which is not incident perpendicularly on the cladding plate has to propagate in it on a longer path, so that the condition for absence of reflection is no longer fulfilled, and the transmission through the cladding plate may be attenuated considerably.

In the applicant's German patent application 10 2004 002 374.3, not pre-published, a cladding plate for a microwave antenna is described, the thickness of which varies locally, so that a radio beam originating from an antenna which is assumed to be point-shaped, and which beam is reflected at a surface of the cladding plate facing the antenna interferes destructively with a radio beam which has passed the surface facing the antenna and was reflected at the opposite surface of the cladding plate.

The modification of the directional characteristic of an antenna caused by such a plate is indeed minimum if the antenna operates exactly at a desired wavelength for which the cladding plate was constructed. If the working wavelength of the antenna deviates from the desired wavelength, reflection at the cladding plate occurs. In that case, the increase of reflectivity is the stronger, the more half-wavelengths the thickness of the cladding plate amounts to. The cladding plate according to DE 10 2004 002 374.3 must therefore be manufactured with a specific thickness for each antenna wavelength. In order to achieve uniform reflection characteristics on the entire surface of the cladding plate, the thickness must be maintained strictly constant. Design and manufacturing efforts are therefore considerable.

The object of the present invention is therefore to provide a cladding for a microwave antenna which can be used without modification of its shape for antennas within a broad frequency range.

The object is achieved by a cladding for a microwave antenna having at least one cladding plate, in which the cladding plate, in a section along a first section plane, has a plurality (i. e. at least two) regions, in each of which a vector issuing from one of said regions at an angle α with respect to the surface normal intersects a vector issuing in the same way from each other region in a same point, the angle α fulfilling the condition

tan α=\sqrt{ε_{R}},

wherein ε_{R} is the dielectric constant of the material of the cladding plate.

The thus defined angle α is the so-called Brewster angle of the cladding plate. A radio beam which is incident on a surface under the Brewster angle α thereof and is polarized in its plane of incidence is transmitted by said surface without reflection. This effect is dependent on the wavelength of the radio beam in question only by means of the wavelength dependence of the dielectric constant ε_{R,} i. e. variations of the Brewster angle are very small within a broad wavelength region. In this way, freedom of reflection of the plate surface can be achieved within a broad wavelength region.

Preferably, several of these regions form a continuous surface portion which has a section in the form of a piece of a logarithmic spiral in a first section plane. This ensures that radio beams from a point-shaped antenna or from an antenna which may be regarded as approximately point-shaped and is located at the origin of the spiral are always incident on said surface portion under the Brewster angle, no matter into which direction they where irradiated from the origin.

In order to reduce the required space of the cladding, it is useful that the cladding be formed of a plurality of portions which have said cross-section in the form of pieces of logarithmic spirals with a same origin in that first section plane.

Two such logarithmic spiral-shaped portions may be connected by a portion which is radially oriented with respect to the origin of the spirals, or by a spiral-shaped portion of opposite direction of rotation, i. e. a portion in which the angle between it and a radius vector has another sign than in the adjacent portions.

According to a first embodiment, each portion may have a straight cross-section in a second section plane perpendicular to the first section plane. This gives an easily feasible cladding for an antenna which is exclusively polarized in the first section plane.

A further improved reflection characteristic, in particular when using an antenna which has a broadly spread beam in the second section plane, is obtained if each portion of the cladding has a circular cross-section in the second section plane and if the centres of the circular cross-sections define a straight line on which the origin of the logarithmic spiral is located.

Another object of the invention is an antenna assembly comprising at least one antenna and a cladding as described above.

In the simplest case, preferably a single antenna is located at the common origin of all vectors or at the common origin of all spiral pieces.

The arrangement of the spiral pieces is preferably symmetric with the respect to a symmetry plane of the directional characteristic of the antenna.

In order to achieve a small installation depth of the antenna assembly in the principal radiation direction of the antenna, it may be provided that ends of two spiral pieces which are close to the origin touch each other in a symmetry plane of the directional characteristic of the antenna.

Further features and advantages of the invention become apparent from the subsequent description of embodiments referring to the appended figures.

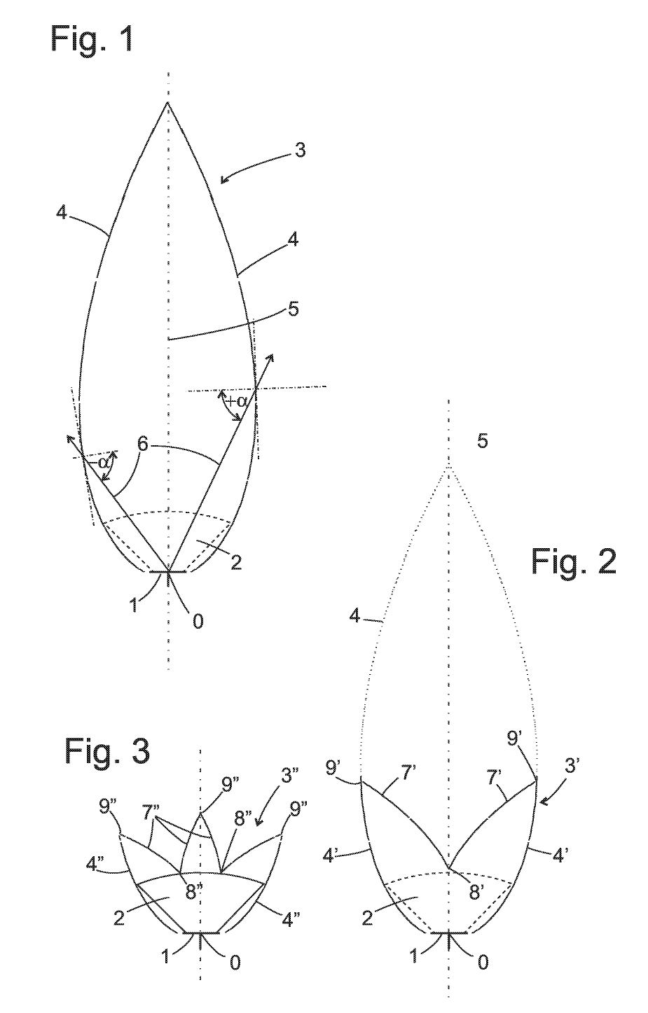

FIG. 1 illustrates a first embodiment of a cladding and of an antenna assembly according to the present invention in a section along a first plane;

FIG. 2 shows an advanced modification of the embodiment of FIG. 1 with reduced installation depth;

FIG. 3 shows a second advanced modification having a further reduced installation depth;

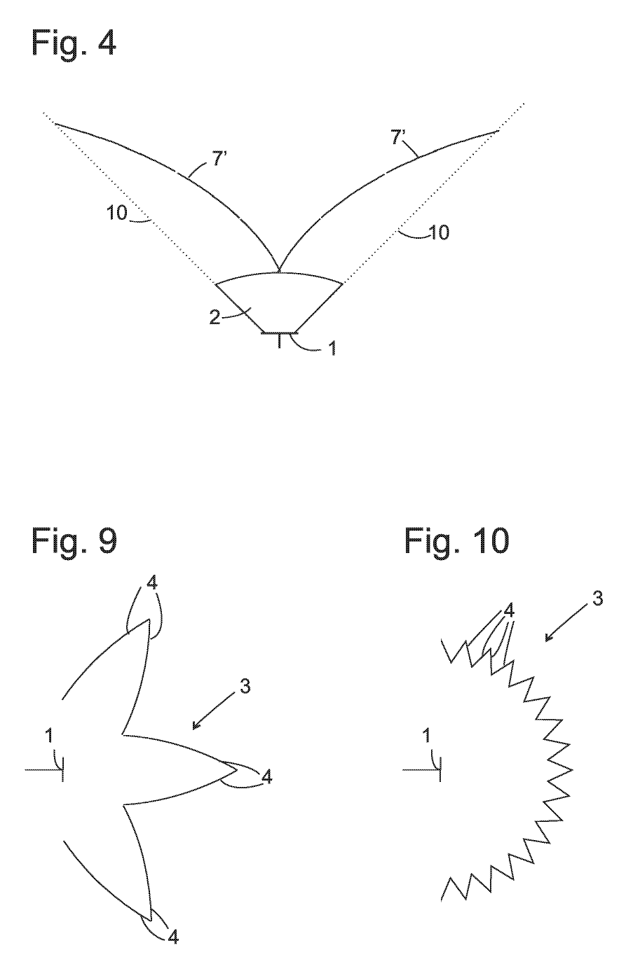

FIG. 4 illustrates a second embodiment of the cladding and of the antenna assembly according to the present invention in a section along the first section plane.

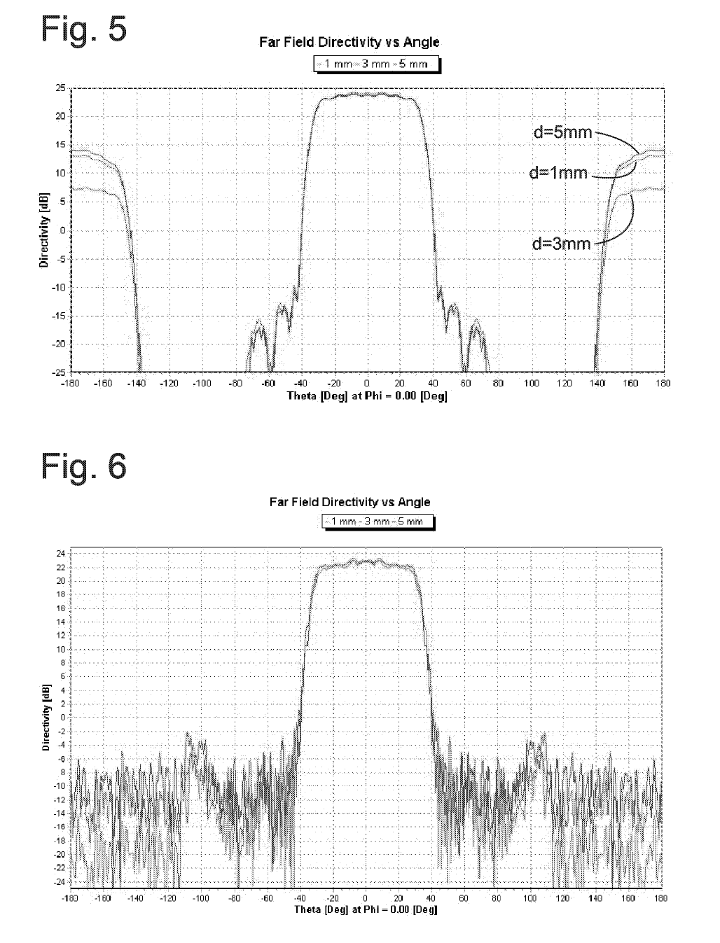

FIG. 5 is the directional characteristic of an antenna assembly having a 45° sector antenna and a conventional cladding in the form of a plane plate for different thicknesses of the plate.

FIG. 6 is the directional characteristic of the antenna assembly of FIG. 3 for different thicknesses of the cladding plate and a polarisation of the antenna which makes use of the Brewster effect;

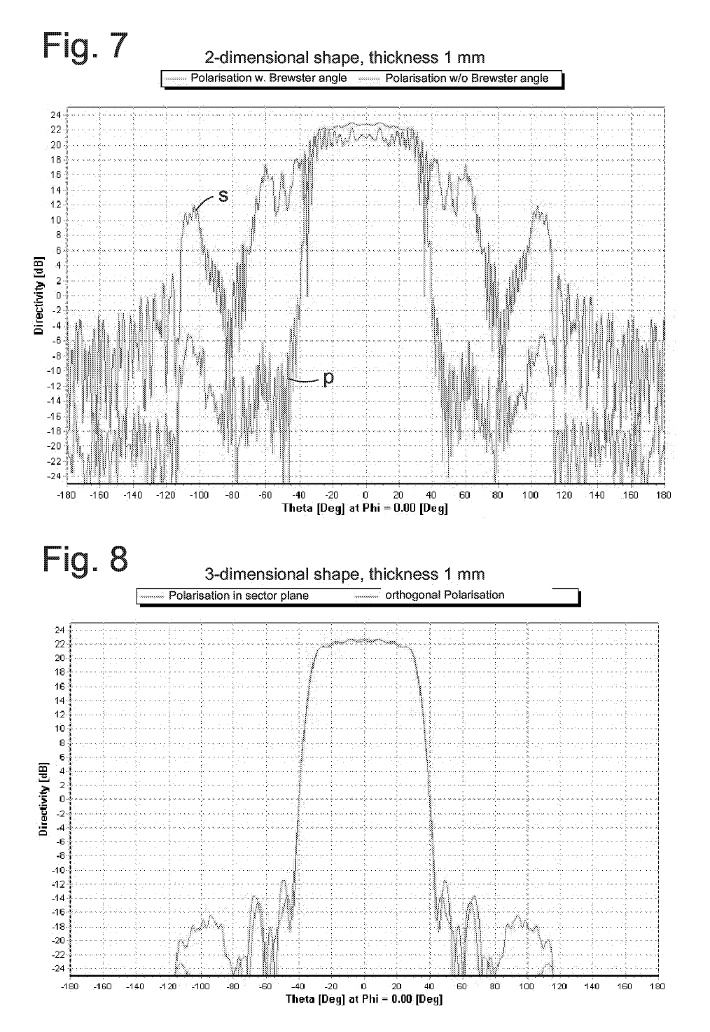

FIG. 7 is the directional characteristic of the assembly of FIG. 3 at a screening thickness of one millimetre, assuming a polarisation of the antenna in the section plane and perpendicular to it, respectively;

FIG. 8 is the directional characteristic of the assembly of FIG. 4, for an antenna polarized in the section plane and perpendicular to it, respectively;

FIG. 9 is a section of a further embodiment of an antenna cladding according to the invention;

FIG. 10 is a section of a further embodiment of an antenna cladding according to the invention;

FIG. 11 is a perspective view of an antenna cladding having the section of FIG. 9 in a horizontal section plane;

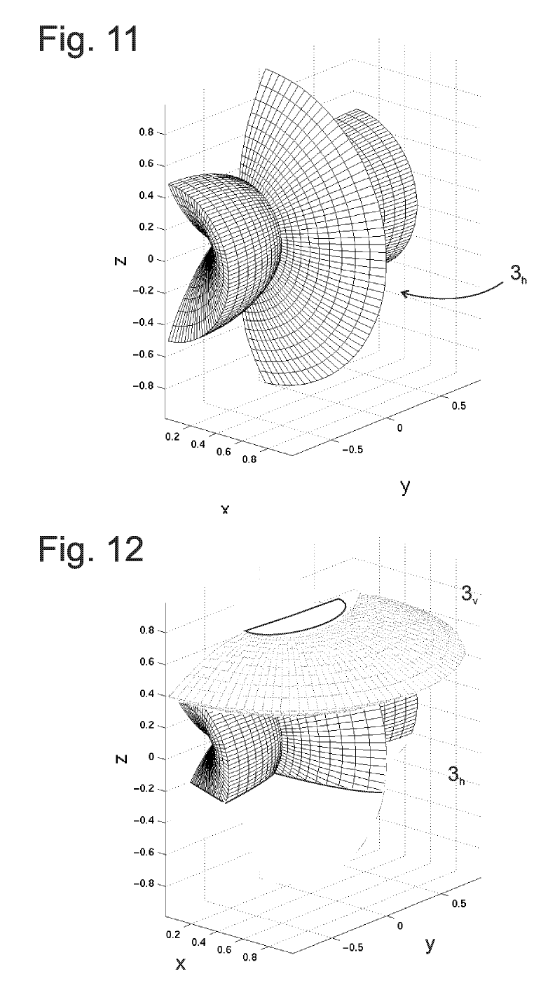

FIG. 12 is a perspective view of a cladding for two antennas;

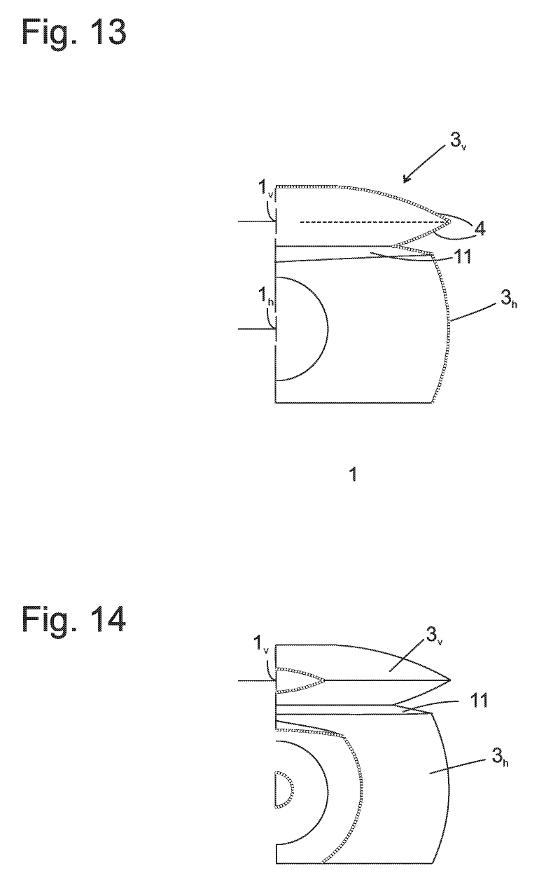

FIG. 13 is central vertical section of the cladding of FIG. 12; and

FIG. 14 is an off-central vertical section of the cladding of FIG. 12.

FIG. 1 illustrates a schematic section of an antenna assembly according to a first, elementary embodiment of the invention. Reference numeral 1 refers to a 45° sector antenna having a polarisation parallel to the section plane of FIG. 1. The structure of antenna 1 need not be discussed further here, since it is not relevant for the present invention. A near field of the antenna is represented as a dashed outline 2. The term near field 2 is to denote the region in the closer vicinity of the antenna 1 in which the electromagnetic field irradiated by the antenna 1 cannot be approximated as the field of a point source located at the origin 0. Conversely, this implies that for describing the behaviour of the antenna 1 outside its near field 2, the antenna 1 may be assumed to be point-shaped.

The antenna 1 is surrounded by a cladding 3 in the form of curved plates or films of a dielectric material. In the case of FIG. 1, there are two plates 4, which face each other in a mirror-symmetric way with respect to a symmetry plane 5 of the directional characteristic of the antenna 1 and have a cross-section in the shape of a logarithmic spiral of origin 0 and opposite rotation directions. The edges of the plates 4 which are remote from the antenna 1 touch each other in the symmetry plane 5.

Due to the logarithmic spiral shape of the cross-section of the plates 4, a radio beam 6 from the antenna always impinges on one of the plates 4 under the same angle +α and −α, respectively. The angle α fulfils the Brewster condition

tan α=\sqrt{ε_{R}}

wherein ε_{R} denotes the dielectric constant of the dielectric material of the plates 4. The angle α is the Brewster angle of the material of the plates 4, so that a beam 6 polarized in the section plane of the Figure goes through the plates 4 without being reflected by them.

It should be noted that here and in the subsequent description, only a field irradiated by the antenna 1 is mentioned, but that the invention is applicable in a same way to a receiving antenna. It cannot be assumed that all electromagnetic radiation which is incident on the cladding 3 from outside fulfils the Brewster condition, but for the radiation which indeed reaches the antenna 1 at the origin 0, the condition is certainly fulfilled.

The cladding 3 of FIG. 1 has a considerable installation depth in the main beam direction of the antenna 1 along the symmetry plane 5. This installation depth cannot be simply reduced by a scale reduction of the cladding 3, because then part of the plates 4 would extend in the near field 2, in which, since the antenna 1 can no longer be approximated as a point source, partial reflection would occur. A considerable reduction of the installation depth of the antenna assembly in the main beam direction is achieved by the embodiment of FIG. 2. In order to illustrate the extent of the reduction of installation depth, the near field 2 is shown in FIG. 2 in the same scale as in FIG. 1, and the outline of the cladding plates 4 of FIG. 1 is drawn in FIG. 2 as a dotted line.

The cladding 3′ of FIG. 2 is formed of four plates 4′, 7′ of spiral-shaped cross-section, of which the two outer plates 4′ are congruent with the plates 4 of FIG. 1, but are considerably reduced in width. Two further spiral-shaped plates 7′ extend with opposite rotation directions from a common apex 8′, which is located on the symmetry plane 5 just outside the near field 2, to intersection points 9′ with the outer plates 4′. The dimension of the antenna assembly in the symmetry plane 5 is reduced to approximately a third with respect to the assembly of FIG. 1.

A still more compact form of the cladding is shown in FIG. 3 in the same scale as before. Here the cladding 3″ is formed of six plates 4″, 7″ shaped as logarithmic spirals with alternating rotation directions which touch each other at their ends. In FIG. 3, the dimensions of all four plates 7″ are identical for the sake of simplicity; the installation depth in the main beam direction might be reduced still further if the dimensions of the plates 4″, 7″ are selected such that the two apices 8″ which are close to the origin are located at the border of the near field and the three apices 9″ remote from the origin are located on a same line perpendicular to the central plane 5.

In FIG. 4, a second embodiment of the antenna assembly is shown which may be regarded to be derived from the embodiment of FIG. 2 by omitting the outer plates 4′ and prolonging the two inner plates 7′ to the outside up to a border of the radiation cone of the antenna 1 represented by a dotted line 10. The cladding of FIG. 4 may be closed at the sides by non-represented plates which extend straight along the line 10 or outside this line in a region into which the antenna 1 does not significantly irradiate and where, accordingly, the course of these walls does not influence the directional characteristic of the complete assembly.

FIGS. 5 to 8 are directional characteristics of an antenna assembly having a 45° sector antenna and a conventional cladding and a cladding according to different embodiments of the present invention, respectively.

FIG. 5 is the directional characteristic of an antenna assembly having a conventional cladding in the form of a plane cladding plate perpendicular to the main beam direction of the antenna, for thicknesses d of the cladding plate of one, three and five millimetres, respectively, and a transmission frequency of 26 GHz. The curve shapes for the transmitted beam do not differ considerably for the three thicknesses. However, a distinct mirror-image of the beam is recognized at angles around ±180°, which, in the most favourable case of a thickness d of 3 mm, is attenuated by approximately 17 dB with respect to the main beam.

FIG. 6 is the directional characteristic of a first antenna assembly according to the invention, having an antenna cladding of the type shown in FIG. 3 and an antenna polarized horizontally, in the section plane of FIG. 3. Outside of the sector of the antenna, the intensity varies strongly with the azimuth angle θ, so that the curves shown in the diagram for thicknesses d of the cladding of 1, 3 and 5 mm are difficult to tell apart. There is no noticeable quality difference between the directional characteristics of the different thicknesses. Regardless of the thickness of the cladding, the attenuation outside of the antenna sector is better than 24 dB everywhere, and a reflected beam is not noticeable.

FIG. 7 illustrates two directional characteristics p and s for an antenna cladding of the type shown in FIG. 3, each for a material thickness of 1 mm. The curve denoted p is one of the three curves also shown in FIG. 6. It is to be seen that for the material thickness d=1 mm the attenuation outside of the antenna sector is at least 27 dB. The curve denoted s illustrates the directional characteristic of an antenna assembly which differs from that of curve p by the polarisation of the radiation of the antenna, perpendicular to its plane of incidence on the cladding. The directional characteristic of curve p is completely degraded.

Some further modifications of the antenna cladding of the invention are explained referring to FIGS. 9 to 13.

FIG. 9 is a schematic section of an antenna 1 and its cladding 3, in which the cladding is formed of three identical elements, each of which comprises two plates 4 of spiral-shaped cross-section, wherein each element, as seen from the antenna 1, extends over an angle of 60 degrees in the section plane.

As is easily understood, the number of identical elements of which the cross-section of the claddings of the invention are formed may be made as high as desired; in the limit, the number may be made so large or the individual elements may made so small that their spiral curvature is negligible and they may be regarded as plane segments arranged under the Brewster angle.

FIG. 10 illustrates this case by a schematic section of an antenna 1 and its cladding 3. Since the plates may be planar in this embodiment, the manufacture of the cladding is simplified considerably. However, in this embodiment, there is a possibility that the edges which exist in large numbers between the individual plates 4, and which form zones that do not fulfil the Brewster condition, may scatter the radiation of the antenna in an undesired way.

FIG. 11 is a perspective view of an antenna cladding 3ₕ which has the cross-section shown in FIG. 9 in a section along its horizontal central plane (the plane z=0 in the coordinate system of the Figure) and which has a semi-circular cross-section in any section plane perpendicular to the y-axis. The cladding 3ₕ has a negligible reflection for horizontally polarized radiation emitted by an antenna placed at the origin of the coordinate system. For vertically polarized radiation emitted by the same antenna, the Brewster condition is not fulfilled. In order to fulfil it for this latter type of radiation, it would be sufficient to rotate the cladding 3ₕ of FIG. 11 by 90° around the main beam axis of antenna 1.

An antenna cladding 3 for two sector antennas 1ₕ, 1ᵥ with a small beam spread in the elevation direction is shown in FIG. 12 to 14 in a perspective view and in section along the planes y=0 and y=−0.5, respectively, of FIG. 12. The antenna cladding 3 is formed of two segments, a lower segment 3ₕ, the shape of which corresponds to the cladding 3ₕ of FIG. 11 in the coordinate interval −0.4<z<+0.4 0.4, and which screens the radiation cone of a horizontally polarized antenna 1ₕ located at the origin x=y=z=0 of the coordinate system. The segment 3ₕ screens the antenna 1ₕ in an azimuth angle range of 180° but only in a much smaller elevation angle region of approximately 50° in the present case. Since the spread of the beam of a sector antenna in elevation is usually much smaller than in azimuth, practically all radiation power of the antenna 1ₕ passes the segment 3ₕ.

The upper segment 3ᵥ shaped like a half discus corresponds to the central portion of cladding 3ₕ of FIG. 11, rotated by 90°. It screens the vertically polarized antenna 1ᵥ placed at approximately x=y=0, z=0.4 without reflection. Here, too, practically all transmission power of the antenna 1ᵥ passes through the segment 3ᵥ.

The two segments 3ₕ, 3ᵥ are continuously connected to each other by a conical surface 11.

1-12. (canceled)

14. A cladding for a microwave antenna, the cladding comprising:
at least one cladding plate having a plurality of regions in a section along a first section plane, wherein a vector issuing from one region at an angle α with respect to a surface normal intersects the same point as a vector issuing from any other region at the angle α with respect to a surface normal, the angle α fulfilling the condition
tan α=\sqrt{ε_{R}},
wherein ε_{R} is a dielectric constant of the cladding plate material.

15. The cladding of claim 14 wherein the plurality of regions forms a continuous surface portion having a cross-section in the shape of a portion of a logarithmic spiral in the first section plane.

16. The cladding of claim 15 wherein the cladding plate further comprises a plurality of surface portions having cross-sections in the shape of portions of logarithmic spirals of the same origin in the first section plane.

17. The cladding of claim 16 wherein at least two surface portions are connected by a surface portion oriented radially with respect to the origin of the logarithmic spirals.

18. The cladding of claim 16 wherein logarithmic spiral-shaped surface portions that contact each other have section angles α of the same amount but opposite signs.

19. The cladding of claim 16 wherein each surface portion has a straight cross-section in a second section plane perpendicular to the first section plane.

20. The cladding of claim 16 wherein each surface portion has a cross-section in the shape of a circular arc in a second section plane perpendicular to the first section plane, the centers of said circular arc-shaped sections and the origin of the logarithmic spiral of the portion being located on a straight line.

21. The cladding of claim 14 wherein the cladding is formed to have a cross-section in the shape of at least a fragment of a star in the first section plane.

22. An antenna assembly comprising:
a microwave antenna; and
a cladding comprising at least one cladding plate having a plurality of regions in a section along a first section plane, wherein a vector issuing from any region at an angle α with respect to a surface normal intersects the antenna, the angle α fulfilling the condition
tan α=\sqrt{ε_{R}},
wherein ε_{R} is a dielectric constant of the cladding plate material.

23. The antenna assembly of claim 22 wherein the cladding plate comprises a plurality of surface portions disposed to be symmetric with respect to a symmetry plane of a directional characteristic of the antenna.

24. The antenna assembly of claim 23 wherein the ends of two surface portions contact each other along the symmetry plane.

25. The antenna assembly of claim 22 wherein the microwave antenna is polarized in the first section plane.
